(19) United States
(12) Patent Application Publication
(10) Pub. No.: US 2010/0156734 A1
(43) Pub. Date: Jun. 24, 2010

(54) Chip-type antenna for receiving FM broadcasting signal and a manufacturing method thereof

(76) Inventors: Chih-Ming Chen, Neipu Township (TW); Chih-Wei Chen, Houlong Township (TW); Chih-Hao Lai, Guansi Township (TW); Ming-Yi Wu, Miaoli City (TW); Tzu-Feng Lee, Baoshan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/314,940

(22) Filed: Dec. 19, 2008

(51) Int. Cl. H01Q 7/06; B05D 5/12; C25D 5/54

(52) U.S. Cl. 343/788; 427/123; 205/162

(57) ABSTRACT

A chip-type antenna for receiving FM broadcasting signal includes a ceramic substrate, a ferrite layer formed on a top surface of the ceramic substrate, and a radiation structure. The ceramic substrate and the ferrite layer form an antenna substrate. The radiation structure is formed on the antenna substrate. The chip-type antenna for receiving FM broadcasting signal utilizes the high dielectric constant of the ceramic substrate and the electric characteristic of the ferrite layer to reduce the dimension of the antenna.

### BACKGROUND OF THE INVENTION

1. Field of the Invention

The present invention relates to a chip-type antenna for receiving FM broadcasting signal and a manufacturing method thereof. In particular, the present invention relates to a small-dimension chip-type antenna for receiving FM broadcasting signal and a manufacturing method thereof.

2. Description of Related Art

As the semiconductor manufacturing technology is developed, the functions of the semiconductor chip are improved and increased so that the signal transmission rate of the semiconductor chip increases. When the information technology products become small and light to be the important mobile devices for people, especially laptops, mobile communication devices, digital still cameras, and meets the requirements of being small to fully utilize the space of the housing, each module for the information technology products should be stable and efficient. How to reduce the dimension of the module and maintain the high quality of the module and enhance the data transmission rate and signal quality is a top issue for the manufacturers.

Furthermore, the multi-medium functions are added to the cell phone, or the mobile electronic devices are built-in with FM broadcasting function to provide a lot of functions for the user. However, because the receiving frequency of FM signal receiving device is between 85 MHz and 108 MHz, a longer or a large-dimension antenna is required to receive FM signal with the frequency between 85 MHz and 108 MHz. For example, the radio player has the STD FM single-pole antenna, or the cell phone uses the external earphone wire to receive FM signal. The described antennas are usually made of copper wire or the single-core wire to receive FM signal.

As the mobile electronic device is developed, the function of FM antenna is inadequate for the mobile device. For example, the dimension of the STD FM antenna is large so that the STD FM antenna cannot be applied the small-scaled cell phone. Moreover, the structure strength of the STD FM antenna is weak so that the STD FM antenna is easily bent, or broken. In the other side, it is inconvenient for the user to use the external earphone wire to receive the signal. As the Bluetooth technology is great applied the mobile communication, the external earphone wire becomes not popular for the user.

### SUMMARY OF THE INVENTION

One particular aspect of the present invention is to provide a chip-type antenna for receiving FM broadcasting signal and a manufacturing method thereof. The antenna is applied to FM broadcasting system. The antenna utilizes the electric characteristic generated from a ceramic substrate and a ferrite layer to reduce the dimension of the antenna for receiving FM signal. Furthermore, the antenna can be manufactured into a chip-type that is suitable for a small-scale electronic device to add the device's value.

The chip-type antenna for receiving FM broadcasting signal includes a ceramic substrate, a ferrite layer formed on a first surface of the ceramic substrate, and a radiation structure. The ceramic substrate and the ferrite layer form an antenna substrate. The radiation structure is formed on the antenna substrate.

The present invention also provides a manufacturing method for a chip-type antenna for receiving FM broadcasting signal, and the method includes the following steps. An antenna substrate is provided. The antenna substrate is composed of a ceramic substrate and a ferrite layer formed on the upper surface of the ceramic substrate. A radiation structure is printed on the back surface of the antenna substrate. A radiation structure is printed on the front surface of the antenna substrate. Finally, a burning process is performed to form a chip-type antenna for receiving FM broadcasting signal.

The present invention has the following characteristics. The chip-type antenna for receiving FM broadcasting signal utilizes the electric characteristic generated from a ceramic substrate and a ferrite layer to reduce the dimension of the antenna. Its antenna characteristic is still well. The chip-type antenna for receiving FM broadcasting signal is a low-profile structure so that the antenna can be easily integrated with the system circuit of the microwave substrate, and meets the requirements of the electronic device being small and light.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a top view of the chip-type antenna for receiving FM broadcasting signal of the present invention;

FIG. 1A is a bottom view of the chip-type antenna for receiving FM broadcasting signal of the present invention;

FIG. 1B is a side view of the chip-type antenna for receiving FM broadcasting signal of the present invention;

FIG. 2 is a schematic diagram of the structure of the chip-type antenna for receiving FM broadcasting signal of the present invention;

FIG. 3 is a schematic diagram of the chip-type antenna for receiving FM broadcasting signal of the second embodiment of the present invention;

FIG. 4 is a schematic diagram of the chip-type antenna for receiving FM broadcasting signal of the third embodiment of the present invention;

FIG. 5 is a flow chart of the manufacturing method for a chip-type antenna for receiving FM broadcasting signal of the present invention; and

FIGS. 6A˜6C are curve diagram of the RSSI of the chip-type antenna for receiving FM broadcasting signal and two traditional antennas.

### DETAILED DESCRIPTION OF PREFERRED EMBODIMENTS

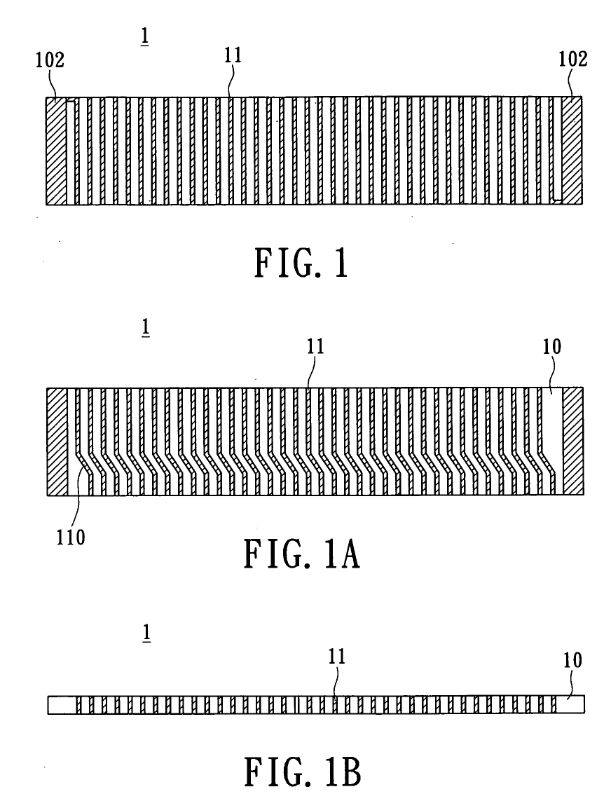

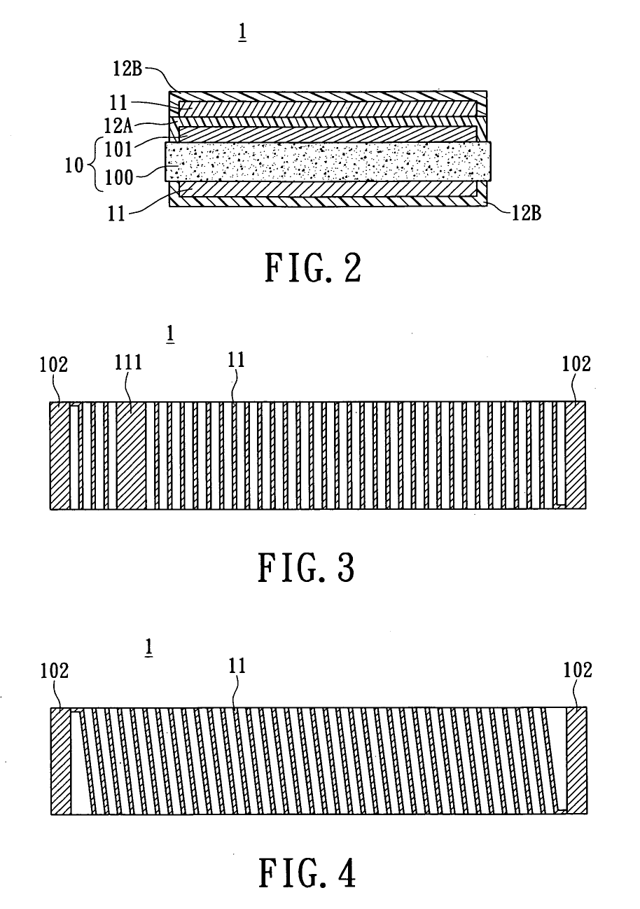

Reference is made to FIGS. 1 and 2. The chip-type antenna for receiving FM broadcasting signal 1 includes a ceramic substrate 100, a ferrite layer 101, and a radiation structure 11. The ceramic substrate 100 and the ferrite layer 101 construct as an antenna substrate 10. The antenna substrate 10 has two characters: the high dielectric constant of the ceramic substrate 100 and electric characteristic of the ferrite layer 101 so that the dimension of the chip-type antenna for receiving FM broadcasting signal 1 can be reduced. The ferrite layer 101 is formed on a first surface (i.e. top surface) or the second surface (i.e. bottom surface) of the ceramic substrate 100, or both the first surface and the second surface of the ceramic substrate 100. In other words, the ferrite layer 101 is selectively formed on the surfaces of the ceramic substrate 100 to form the antenna substrate 10 so that the antenna substrate 10 has high dielectric constant and specific electric characteristic. The radiation structure 11 is formed on the antenna substrate 10 to be the chip-type antenna for receiving FM broadcasting signal 1.

FIGS. 1, 1A and 1B show the chip-type antenna for receiving FM broadcasting signal 1 of the first embodiment of the present invention. Reference is also made to FIG. 2. The chip-type antenna for receiving FM broadcasting signal 1 includes an antenna substrate 10, and a radiation structure 11. The antenna substrate 10 is composed of a ceramic substrate 100 and a ferrite layer 101. In this embodiment, the ceramic substrate 100 is made of aluminum oxide. The ferrite layer 101 is a layer formed by coating the ferrite materials, including iron, cobalt, nickel and so on, on the top surface of the ceramic substrate 100. The radiation structure 11 is formed by winding the metal strip around the antenna substrate 10 for receiving FM singles. Reference is made to FIG. 1, which is the top view of the chip-type antenna for receiving FM broadcasting signal 1 and shows the disposition of the metal strip around the antenna substrate 10. The antenna substrate 10 is rectangular. The metal strip extends from the top surface of the antenna substrate 10 in a direction that is vertical to the longer side of the rectangular antenna substrate 10, and extends to one side surface of the antenna substrate 10 (as shown in FIG. 1B). Next, the metal strip extends to the bottom surface of the antenna substrate 10 (as shown in FIG. 1A). The above steps are repeated to form the radiation structure 11 wounded around the antenna substrate 10. When the metal strip is wounded to the bottom surface of the antenna substrate 10, the metal strip forms at least one bending portion 110. The bending portion 110 can prevent the metal strip on the top surface and the metal strip on the bottom surface from overlapping so that the canceling problem of the currents on the top surface and the bottom surface is solved. Furthermore, the bending portion 110 can prevent the metal strip from generating the coupling symptom.

FIG. 2 is the schematic diagram of the structure of the chip-type antenna for receiving FM broadcasting signal 1 of the first embodiment of the present invention. The ferrite layer 101 is coated on the top surface of the ceramic substrate 100 to form the antenna substrate 10. The metal strip is wound around the antenna substrate 10. In FIG. 2, the ferrite layer 101 is coated on the top surface of the ceramic substrate 100. Alternatively, the ferrite layer 101 can be coated on the bottom surface of the ceramic substrate 100, or both the top surface and the bottom surface of the antenna substrate 10.

The chip-type antenna for receiving FM broadcasting signal 1 of the first embodiment of the present invention utilizes the vertical metal strip to connect to the side surface of the ceramic substrate 100 to form the radiation structure 11. That can prevents the currents on two adjacent metal strip with opposite directions from canceling out each other, and overcomes the problem of a longer resonance path being required due to the antenna resonance path becomes shorter.

Moreover, there is a first protection layer 12A located between the ferrite layer 101 and the metal strip (the radiation structure 11) of the antenna substrate 10. There is a second protection layer 12B located above the metal strip (the radiation structure 11) on the top surface and the bottom surface of the antenna substrate 10. Thereby, the circuit and the substrate are protected.

Reference is made to FIG. 1 again. Each of two sides of the antenna substrate 10 respectively forms a welding portion 102. The two ends of the metal strip are respectively and electrically connected with the welding portions 102 located at the two sides of the antenna substrate 10. One of the two welding portions 102 is a feeding-in terminal, and anther welding portion 102 is a welding terminal for fastening.

Reference is made to FIG. 3, which shows the second embodiment of the present invention. The difference between the second embodiment and the first embodiment is that the metal strip which is located on the first surface of the antenna substrate 10 (or the second surface, depending on the structure or the characteristic of the antenna) forms a grounding structure 111. The grounding structure 111 is used for connecting with the grounding terminal of the external circuit board.

Reference is made to FIG. 4, which shows the third embodiment of the present invention. The difference between the third embodiment and the above two embodiments is that the metal strip is not vertically wound around the antenna substrate 10. The metal strip is wound around the antenna substrate 10 with an angle to achieve the same effect, and reduce the dimension of the antenna.

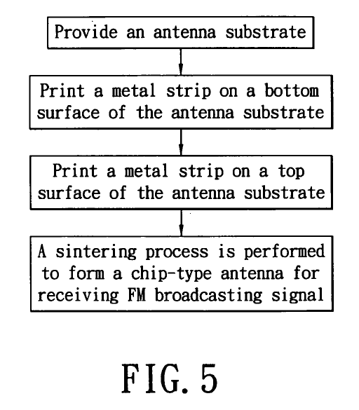

Reference is made to FIG. 5. The present invention also discloses a manufacturing method for a chip-type antenna for receiving FM broadcasting signal 1. The thickness of the antenna substrate 10 is around 1 mm. The chip-type antenna for receiving FM broadcasting signal 1 is manufactured by a thick-film printing process. The manufacturing method includes the following steps.

Step 1: An antenna substrate 10 is provided. The antenna substrate 10 is constructed by a ceramic substrate 100 and a ferrite layer 101 formed on the top surface of the ceramic substrate 100. The antenna substrate 10 has properties including the high dielectric constant of the ceramic substrate 100 and the electric characteristic of the ferrite layer 101 so as to reduce the dimension of the antenna. In this embodiment, the ferrite layer 101 is formed on the top surface of the ceramic substrate 100.

Step 2: A radiation structure 11 is printed on the bottom surface of the antenna substrate 10. A thick-film printing process is performed on the bottom surface of the antenna substrate 10 to form the metal strip with a radiation pattern on the bottom surface of the antenna substrate 10. After this process, a baking process is performed to fix the metal strip on the surface of the antenna substrate 10.

Step 3: A radiation structure 11 is printed on the top surface of the antenna substrate 10. In this step, a thick-film printing process is performed on the ferrite layer 101 to form the metal strip with a radiation pattern on the to surface of the antenna substrate 10, and the metal strips on the top surface and the bottom surface of the antenna substrate 10 are connected so as to form a complete radiation structure 11 (as shown in FIG. 1B). After this process, a baking process is performed to fix the metal strip on the surface of the antenna substrate 10.

Step 4: A sintering process is performed to form a chip-type antenna for receiving FM broadcasting signal 1. In this embodiment, the sintering temperature is 850° C.

After the sintering process, a step of forming a protection layer is included.

Step A: A protection layer is printed above the radiation structure 11 on the bottom surface of the antenna substrate 10. Then, a step B of baking is performed. Next, a protection layer on the top surface of the chip-type antenna for receiving FM broadcasting signal 1 is manufactured. Step C: A protection layer is printed above the radiation structure 11 on the top surface of the antenna substrate 10, and step D of baking is performed. Thereby, the second protection layers 12B are formed above the metal strips on the top surface and the bottom surface of the antenna. Moreover, the first protection layer 12A located between the ferrite layer 101 of the antenna substrate 10 and the metal strip also can be manufactured by the same processes.

Finally, in order to electrically connect the chip-type antenna for receiving FM broadcasting signal 1 with an external circuit, a silver-staining process and an electroplating process are included after the antenna body is finished so that the chip-type antenna for receiving FM broadcasting signal 1 is connected with an external circuit to receive and transmit the signals.

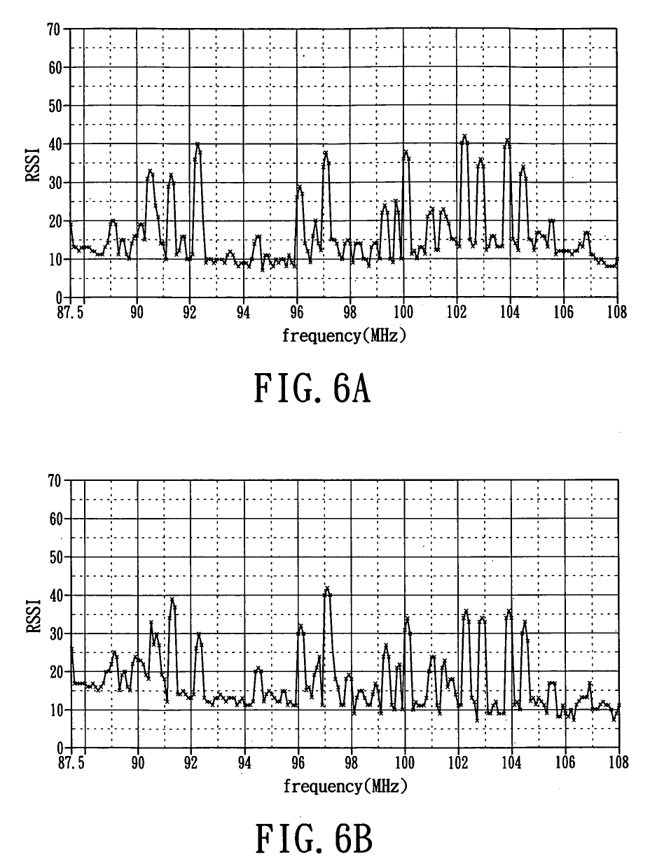

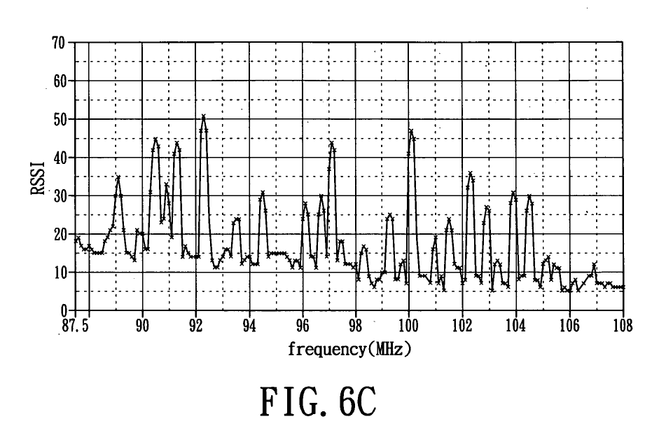

Reference is made to FIGS. 6A˜6C, which show the received signal strength indication (RSSI) of the chip-type antenna for receiving FM broadcasting signal 1, STD FM antenna and the external earphone. FIG. 6A is broadcasting signal strength of the chip-type antenna for receiving FM broadcasting signal 1. FIG. 6B is broadcasting signal strength of the STD FM antenna with a length of 45 cm. FIG. 6C is broadcasting signal strength of the external earphone with a length of 135 cm. The RSSI value of the present invention is similar to the STD FM antenna. However, the dimension of the chip-type antenna for receiving FM broadcasting signal 1 (1 mm) is smaller than the dimension of the STD FM antenna (45 cm). Therefore, the chip-type antenna for receiving FM broadcasting signal 1 can overcome the drawbacks of the STD FM antenna.

The present invention has the following characteristics:

1. The chip-type antenna for receiving FM broadcasting signal 1 of the present invention has properties of the high dielectric constant of the ceramic substrate and the electric characteristic of the ferrite layer to reduce the dimension of the metal strip of the radiation structure. Thereby, the dimension of the antenna is reduced, and the characteristic of the antenna is maintained well so that the chip-type antenna for receiving FM broadcasting signal 1 is suitable for the receiving system of FM broadcasting of the mobile communication device.

2. The chip-type antenna for receiving FM broadcasting signal of the present invention utilizes the electric characteristic of the ceramic substrate and of the ferrite layer to reduce the dimension, and maintain the same quality of the antenna. Furthermore, the chip-type antenna for receiving FM broadcasting signal is a low-profile structure so that the chip-type antenna for receiving FM broadcasting signal can be easily integrated with the microwave substrate to improve the integration of the total system and meet the requirements of the electronic devices.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A chip-type antenna for receiving FM broadcasting signal, comprising:
a ceramic substrate;
a ferrite layer formed on a first surface of the ceramic substrate, wherein the ceramic substrate and the ferrite layer form an antenna substrate; and
a radiation structure formed on the antenna substrate.

2. The chip-type antenna for receiving FM broadcasting signal as claimed in claim 1, wherein the ferrite layer further is formed on a second surface opposite to the first surface of the ceramic substrate.

3. The chip-type antenna for receiving FM broadcasting signal as claimed in claim 2, wherein the radiation structure is formed by winding a metal strip around the antenna substrate.

4. The chip-type antenna for receiving FM broadcasting signal as claimed in claim 3, wherein the antenna substrate is a rectangular antenna substrate.

5. The chip-type antenna for receiving FM broadcasting signal as claimed in claim 4, wherein the metal strip winds around the antenna substrate in a direction that is vertical to the longer side of the antenna substrate.

6. The chip-type antenna for receiving FM broadcasting signal as claimed in claim 5, wherein the metal strip forms a bending portion on the second surface of the antenna substrate.

7. The chip-type antenna for receiving FM broadcasting signal as claimed in claim 6, wherein the antenna substrate has welding portions on two sides thereof.

8. The chip-type antenna for receiving FM broadcasting signal as claimed in claim 7, wherein two ends of the metal strip electrically connect with the welding portions located at the two sides of the antenna substrate.

9. The chip-type antenna for receiving FM broadcasting signal as claimed in claim 8, wherein the metal strip further forms a grounding structure.

10. The chip-type antenna for receiving FM broadcasting signal as claimed in claim 9, wherein the ceramic substrate is made of aluminum oxide.

11. The chip-type antenna for receiving FM broadcasting signal as claimed in claim 10, further comprising a first protection layer formed between the ferrite layer of the antenna substrate and the radiation structure.

12. The chip-type antenna for receiving FM broadcasting signal as claimed in claim 11, further comprising a second protection layer formed above the radiation structure.

13. A manufacturing method for a chip-type antenna for receiving FM broadcasting signal, comprising:
(a) providing an antenna substrate, wherein the antenna substrate is constructed by a ceramic substrate and a ferrite layer formed on the upper surface of the ceramic substrate;
(b) printing a radiation structure on a bottom surface of the antenna substrate;
(c) printing a radiation structure on a top surface of the antenna substrate; and
(d) forming a chip-type antenna for receiving FM broadcasting signal by a sintering process.

14. The manufacturing method for a chip-type antenna for receiving FM broadcasting signal as claimed in claim 13, wherein a baking process is further included between step (a) and step (b), and step (b) and step (c).

15. The manufacturing method for a chip-type antenna for receiving FM broadcasting signal as claimed in claim 14, further comprising the following steps after step (d):
(e) printing a protection layer on the radiation structure located on the bottom surface of the antenna substrate;
(f) performing a baking process;
(g) printing a protection layer on the radiation structure located on the top surface of the antenna substrate; and
(h) performing a baking process.

16. The manufacturing method for a chip-type antenna for receiving FM broadcasting signal as claimed in claim 15, further comprising the following steps after step (h):
(i) performing a silver-staining process; and
(j) performing an electroplating process.
